(19) United States
(12) Patent Application Publication
(10) Pub. No.: US 2007/0063584 A1
(43) Pub. Date: Mar. 22, 2007

(54) SNOWMOBILE TRACTION BAND

(76) Inventor: Yves St-Pierre, Wickham (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/531,974

(22) Filed: Sep. 14, 2006

(30) Foreign Application Priority Data
Sep. 15, 2005 (CA) 2,519,862

(51) Int. Cl. B62D 55/24

(52) U.S. Cl. 305/169; 305/178

(57) ABSTRACT

The invention relates to an improved traction band for use on a tracked vehicle and more particularly, on a snowmobile. The traction band is made of rubber and comprises a central portion and two opposite lateral portions. Each lateral portion is separated from the central portion by a row of holes defining clip areas. The central portion of the traction band further comprises a series of openings. These openings reduce the noise generated by the traction band when the vehicle is operated.

### FIELD OF THE INVENTION

The present invention pertains to a traction band for a vehicle and more particularly to a traction band for snowmobiles, such a traction band providing reduced noise when the snowmobile is driven at various speeds.

### BACKGROUND

Snowmobiles are very popular in the snow belt area of North America and are becoming popular in other snow-covered regions of the world. Traction bands are now also being fitted on all terrain vehicles (ATV) to facilitate their use on snow-covered surfaces.

Unfortunately, snowmobiles and ATV's can be a source of noise. Although efforts have been made in order to reduce the overall noise level generated by the use of such vehicles, improvements are still needed.

One of the sources of such noise is the noise generated by the movement of the traction band itself.

Numerous efforts have been attempted to reduce traction band generated noise level but without achieving the promised result. See for example Canadian patent 2,182,845. However, such configurations have produced very limited noise reduction, if any.

### OBJECTS AND STATEMENT OF THE INVENTION

It as been found that traction band noise can be reduced if the traction band is provided with openings in its central portion and/or lateral portions.

It is therefore an object of the present invention to provide a traction band for use with a snowmobile, an ATV or other similar vehicles in which a variety of openings are provided in the central portion and/or lateral portions of the traction band. The present invention therefore relates to a traction band, preferably for a snowmobile, comprising an endless body having a ground engaging outer side and a suspension supporting inner side;
a. the body defining a central portion and opposite lateral portions;
b. each lateral portion being interconnected with the central portion via a suspension bearing portion;
   wherein the central portion and/or the lateral portions are provided with a plurality of openings.

Other objects and further scope of applicability of the present invention will become apparent from the detailed description given here and after. It should be understood, however, that this detailed description while indicating preferred embodiments of the invention, is given by way illustration only, since various changes and modifications within the spirit and scope of the invention will become apparent to those skilled in the art.

### BRIEF DESCRIPTION OF THE DRAWINGS

FIG. 1 is a partial isometric view of a portion of a traction band incorporating first embodiment of the invention.

FIG. 2 is a top view of the embodiment shown in FIG. 1.

FIG. 3 is a side view of the traction band shown in FIG. 1.

FIG. 4 is a lateral section of the traction band shown in FIG. 1.

FIG. 5 is a partial isometric view of a portion of a traction band incorporating a second embodiment of the invention.

FIG. 6 is a top view of the embodiment shown in FIG. 5.

FIG. 7 is a side view of the traction band shown in FIG. 5.

FIG. 8 is a lateral section of the traction band shown in FIG. 5.

### DESCRIPTION OF PREFERRED EMBODIMENT

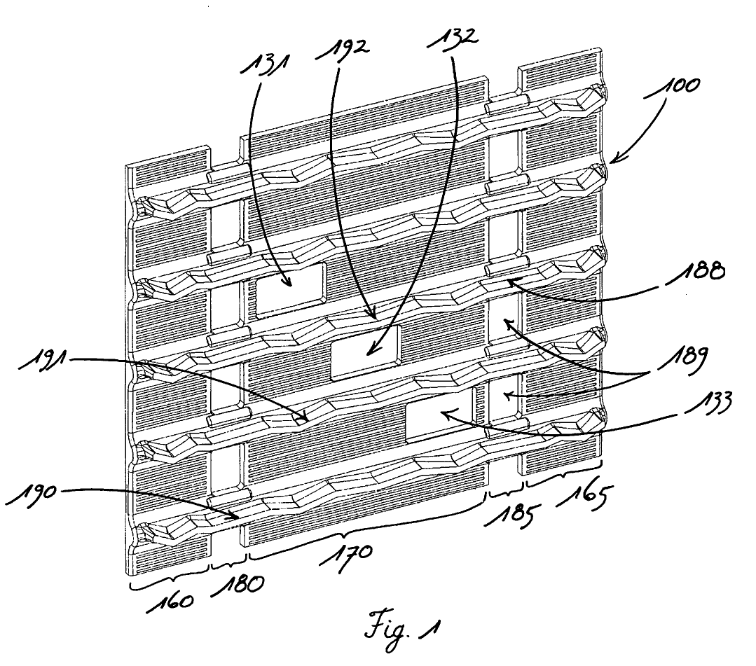

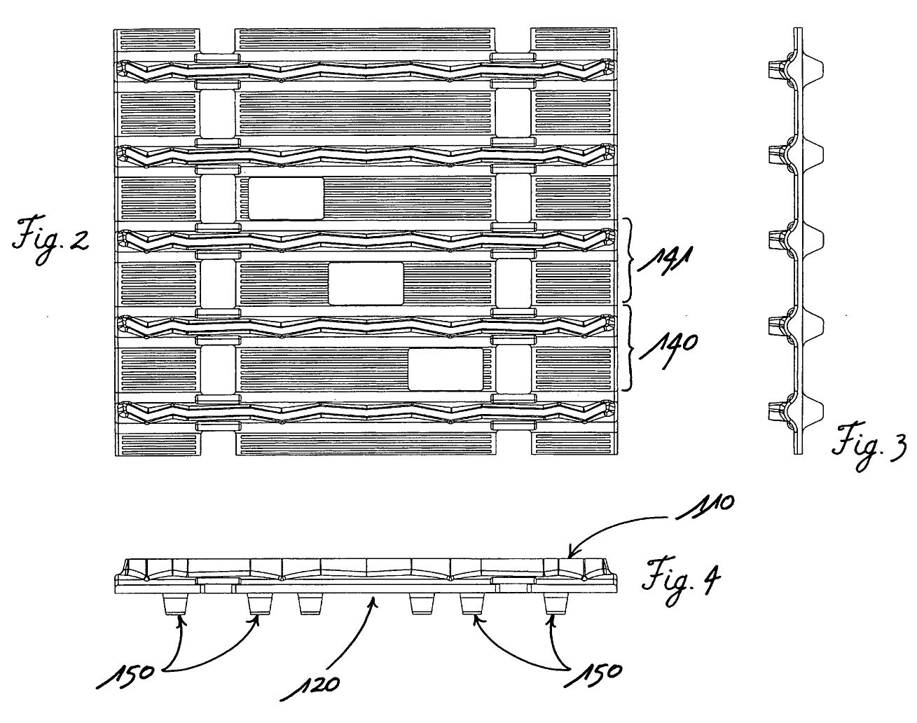

Referring to FIG. 1, there is shown, in part, an endless snowmobile traction band, generally denoted 100 for propelling a snowmobile over snow, ice or other similar ground structures. The mounting of this traction band to a snowmobile is well known and needs not to be detailed. The traction band has a ground engaging outer side 110 and an inner side 120 that receives and support, on the lower run thereof, a suspension which may consist of a wheel assembly or a slide rail assembly, both of which are also well known in the art.

Conventionally, the traction band rotates by means of a motor driven sprocket unit at the forward end of the vehicle and idler/tension wheels are mounted at the rear end of the vehicle to support the rear portion of the traction band.

The sprocket (not shown) comprises a series of teeth which engage a series of lugs 150 integrally formed on the inner surface 120 of the traction band 100. As illustrated in FIG. 1, the traction band defines a pair of opposite lateral portions 160 and 165 and a central portion 170. The central portion is interconnected with each lateral portion by a plurality of longitudinal suspension bearing portions 180 and 185 respectively. Typically, bearing sections 180 and 185 are provided with a series of openings 189 thereby leaving bridge portions 188 which can be covered by metallic clips (not shown). Such clips are usually structured so that, in the case of a slide rail suspension system, the rails that support the chassis of the snowmobile slide on the faces of these clips. See for example U.S. Pat. No. 4,474,414 (Tokue).

A series of ground engaging profiles (190, 191, 192) are provided on the outer surface 110 of the traction band in order to provide traction in the snow.

It has been found that by adding openings (131, 132 and 133) in the central portion 170 of the traction band, noise reduction could be more reliably achieved than by modifying the configuration of such ground engaging profiles. Openings could also be added to the lateral portions of the band while achieving similar results.

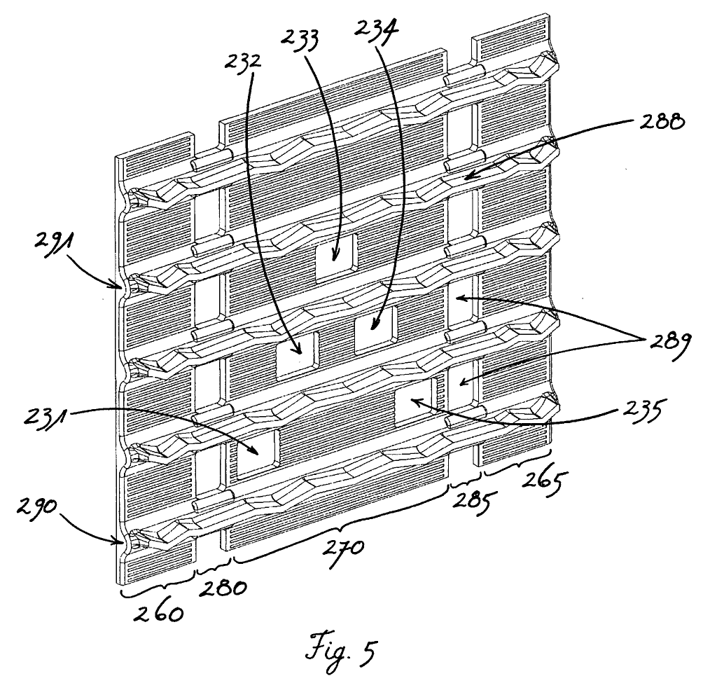

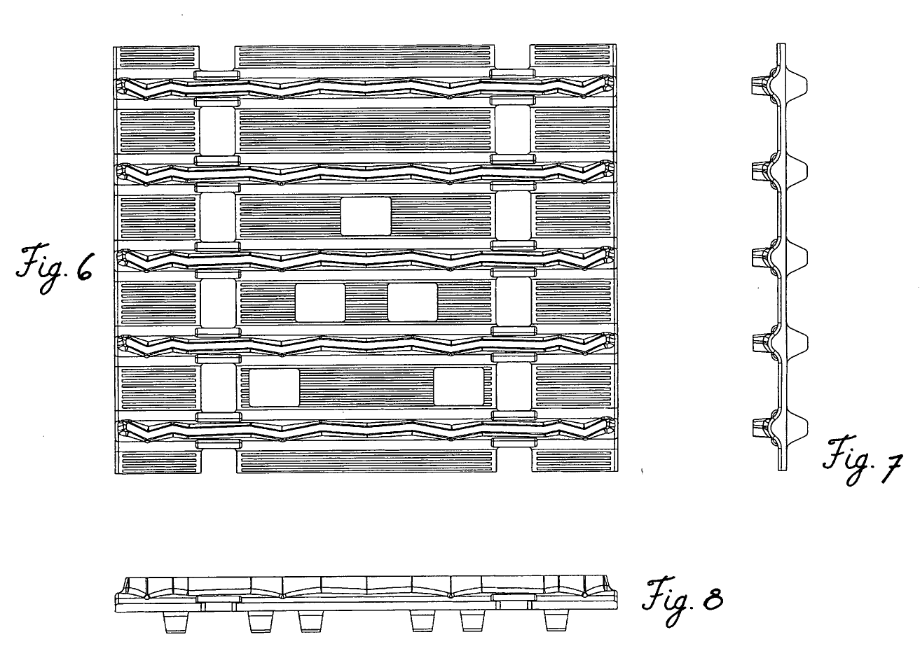

Although FIGS. 1 and 5 show different configurations for the holes in the central portion, other configurations can also produce useful results. It is to be understood that the placement of the holes and their number are not critical. Therefore, other patterns and/or more or less numerous holes could be used to obtain similar results. However, the placement of the holes, their number and their size should be chosen as to not unduly alter the structural integrity of the band.

It is also to be contemplated that other configurations of traction bands could use the present invention and achieve the same objective. For example, traction bands used on wheel replacing traction kit for ATVs have only two side portions connected by plurality of longitudinal suspension bearing portions. This type of traction band does not have a central portion. In that case, the additional openings could be made in the side portions.

Although the invention has been described above with respect to two specific forms, it will be evident to a person skilled in the art that it may be modified in various ways. It is therefore wished to have it understood that the present invention should not be limited in scope, except by the terms of the following claims.

What is claimed is:

1. A traction band for a tracked vehicle comprising an endless body having a ground engaging outer side and a suspension supporting inner side;
a. said body defining a central portion and opposite lateral portions;
b. each said lateral portion being interconnected with said central portion via a suspension bearing portion;
wherein said central portion and/or said lateral portions are provided with a plurality of openings.

2. A traction band as claimed in claim 1, wherein said vehicle is a snowmobile.

3. A traction band as claimed in claim 1, wherein said traction band is divided, along its longitudinal axis, into a plurality of pitch sections and wherein each said pitch section comprises at least one of said openings in said central portion.

4. A traction band as claimed in claim 1, wherein said traction band is divided, along its longitudinal axis into a plurality of pitch sections and wherein each said pitch section comprises at least one of said openings in at least one of said lateral portions.

5. A traction band for a tracked vehicle comprising an endless body having a ground engaging outer side and a suspension supporting inner side;
a. said body defining two side portions;
b. said side portions being interconnected via a suspension bearing portion;
wherein at least one of said side portions is provided with a plurality of openings.

6. A traction band as claimed in claim 1, wherein said traction band is divided, along its longitudinal axis into a plurality of pitch sections and wherein each said pitch section comprises at least one of said openings in at least one of said side portions.

7. A traction band as claimed in claim 1, wherein said vehicle is an ATV.
